(19) United States
(12) Patent Application Publication
(10) Pub. No.: US 2005/0242163 A1
(43) Pub. Date: Nov. 3, 2005

(54) Vapor-operated soldering system and vapor generation system for a soldering system

(75) Inventors: Hans Bell, Berlin (DE); Wilfried Kolb, Ulm (DE)

Correspondence Address: STERNE, KESSLER, GOLDSTEIN & FOX PLLC, 1100 NEW YORK AVENUE, N.W., WASHINGTON, DC, 20005, US

(73) Assignee: Rehm Anlagenbau GmbH, Blaubeuren-Seissen (DE)

(21) Appl. No.: 11/109,880

(22) Filed: Apr. 20, 2005

(30) Foreign Application Priority Data
Apr. 22, 2004 (DE) 10 2004 019 635.4

(51) Int. Cl. B23K 31/02; B23Q 16/00

(52) U.S. Cl. 228/234.2; 228/234.1; 228/9

(57) ABSTRACT

Thermodynamic fluctuations caused conventionally during introduction of a relatively cold liquid into the vapor generator can be reduced considerably or eliminated by providing a preheating region, so that the necessary amount of vapor can be provided in a substantially continuous manner. Vapor generation can here be controlled on the basis of the vapor pressure in the evaporation region, wherein advantageously during operation of a soldering system the pressure in the corresponding process chamber can also be used for control in such a manner that there is always a pressure gradient and additional conveying means, such as pumps for the vapor supply, can thereby be avoided.

### BACKGROUND

1. Field

The present invention generally refers to soldering systems which are operated by means of a heat transfer medium which is present as vapor at least in part during the process. The present invention further refers to a vapor generation system which can be used for such soldering systems, e.g. condensation reflow-soldering systems, repair soldering systems, wave soldering systems, and selective soldering systems.

2. Related Art

When subassemblies are soldered by machine, use is made of soldering systems, for instance reflow soldering systems, in which heat is transferred to the individual components of the subassembly by means of radiation and/or convection of a gas or vapor and also by vapor which when applied to the subassembly will condense, thereby releasing latent heat, so that a corresponding solder is then made to melt and a soldered joint is produced. Especially in condensation soldering systems and vapor-phase soldering systems, a transfer medium is manipulated in the liquid phase at least in part during the process and must be converted into the vapor phase prior to introduction into a corresponding process chamber. The condensation soldering system differs in that the boiling point of the heat transfer medium is higher than the corresponding melting point of the used solder, so that the vapor deposited as condensate leads to a more rapid and more uniform heating of the individual components due to the increased condensation temperature and the released latent heat.

Preferably, polymers based on perfluoropolyether are used as heat transfer media because they are chemically inert, biologically mostly inactive and can be modified by virtue of their molecular composition such that the boiling point can be adjusted within certain limits. For instance, the product Galden LS200 having a boiling point of 200° C., which is preferably used for tin/lead solders, and the product Galden HS240 having a boiling point of 240° C., which is preferably used for lead-free solders, are available and are often employed in condensation soldering systems and vapor-phase soldering systems. To permit a continuous treatment of subassemblies, a corresponding vapor-phase soldering system must comprise corresponding means to provide enough vapor in the process chamber for the soldering process and for possible preheating or cooling processes at all times. To this end the heat transfer medium is normally circulated in the system in the liquid phase and in the vapor phase, and the condensates of the liquid phase arising in the process chamber and possibly in other regions of the soldering system are collected and supplied to a vapor generation system. It has turned out to be advantageous when the volume of the vapor generator is kept as small as possible so that the outer dimensions of the soldering system are not considerably enlarged on the one hand and a shorter response time of the vapor generator is accomplished on the other hand because small volumes of the liquid phase can in principle be evaporated again at a faster pace.

For instance, EP 1157771 describes a vapor-phase soldering system which is operated with superheated vapor, the vapor being generated in a vapor generator outside the process chamber or process chambers used for soldering and preheating and cooling, respectively, and then introduced into the corresponding chambers. Although the system described therein permits an efficient soldering in combination with a desired temperature profile, this document describes the construction of an evaporation system for any desired heat transfer medium only in a very general manner. However, especially when heat transfer media based on perfluoropolyether are used, further difficulties arise because in the case of superheating above 300° C. said medium is subjected to a decomposition process which may lead to a change in the boiling point and produce toxic substances in addition. For soldering processes which are to be carried out with a lead-free solder, Galden HS240© being e.g. used, there is only a relatively small temperature difference at standard pressure between the boiling temperature (240° C.) and the maximally applicable temperature (300° C.) in a corresponding vapor generator, so that the evaporation of an adequate amount of the liquid phase is thereby made more difficult. Furthermore, the liquid phase of said heat transfer medium shows a low thermal conductivity which is e.g. about 15 times lower than the heat conduction of water, so that the heat transfer from a corresponding heating element into the liquid phase is relatively small. Since heat conduction must mainly take place within the liquid phase, only a small part of the liquid volume is normally in direct contact with a corresponding heating surface in conventional systems. Another difficulty is that when approaching the boiling temperature the liquid phase of the heat transfer medium considerably increases in volume, which is e.g. about 37% at 240° C. in the case of HS240©, so that considerable level variations arise particularly in small-sized vapor generators. Moreover, a precise level monitoring of the liquid reservoir is most of the time only possible very inaccurately due to the permanently boiling and thus very turbulent surface, so that there is always the risk of an excessively low level and thus of a fluctuating vapor generation in a vapor generator having only a very small volume.

In general, a vapor generation system for a reflow-soldering system should be able to provide the necessary amount of vapor in continuous fashion, so that the liquid condensates of the heat transfer medium which arise in the soldering process and are again supplied to the vapor generator are efficiently evaporated again. The introduction of a cooled liquid phase of the heat transfer medium, which is e.g. supplied from a collection container or from an external source for compensating for possible circulation losses, may however lead to a sudden decrease or “collapse” in the continuous vapor generation due to the previously explained unfavorable thermodynamic properties of heat transfer media, e.g. the above-described perfluoropolyether materials, with the vapor volume and thus also the vapor pressure in the vapor generator decreasing immediately. The accompanying pressure variations may have a negative effect on the vapor supply to the corresponding process chambers, thereby impairing the possibilities of controlling the vapor volume flowing towards the subassembly to be treated in a desired way.

It is therefore an object of the present invention to provide a vapor phase soldering system and a corresponding vapor generation system which are capable of continuously providing an adequate amount of vapor, with the possibility of observing a small constructional volume of the vapor generation system.

### SUMMARY

According to a first aspect of the present invention this object is achieved by providing a vapor generation system for soldering systems, wherein the vapor generation system comprises an evaporation region configured for evaporation of a heat transfer medium. Furthermore, a preheating region is provided which is configured for heating the heat transfer medium to or above a predefined temperature without exceeding an adjustable upper maximum temperature. Furthermore, the vapor generation system comprises a fluid connection between the evaporation region and the preheating region that is configured to conduct a fluid flow from the preheating region to the evaporation region.

Hence, the construction of the vapor generation system according to the invention provides an evaporation region and a preheating region that are coupled by means of a fluid connection, so that especially the heat transfer medium supplied by a soldering system in the liquid phase can be preheated to a desired temperature before being introduced into the evaporation region. In this process it is possible to reliably prevent an upper maximum temperature incompatible with the heat transfer medium. For instance, the temperature inside the preheating region can be selected such that said temperature is as close as possible to the boiling temperature of the corresponding heat transfer medium, so that upon introduction of the medium preheated in this manner a corresponding collapse in vapor generation in the evaporation region can be substantially avoided. In this context the term “near the boiling temperature” shall characterize a temperature which differs by not more than about 40° C., still more advantageously by not more than about 5° C., from the boiling temperature, the boiling temperature standing for the boiling temperature in the evaporation region. This means that the temperature of the liquid phase in the preheating region may also be above the boiling temperature if a correspondingly high pressure prevails in the preheating region, but the preheating region is configured such that a selected upper maximum temperature is also not exceeded locally in the preheating region. Although the two regions can be fluidically coupled by providing the preheating region, which is coupled by the fluid connection to the evaporation region, the two regions remain mainly decoupled with respect to thermodynamic fluctuations. For instance, the constructional shape and the volume of the preheating region can be chosen such that a high heat transfer from corresponding heaters to the liquid phase of the heat transfer medium is made possible even upon introduction of the liquid at greatly varying temperatures. On the other hand, the evaporation region, for instance, should be configured such that only a relatively small volume of liquid phase must be present because temperature variations can be substantially avoided, thereby permitting an improved controllability in vapor generation due to the reduced fluctuations and the small fluid volume in comparison with conventional vapor generation systems.

In another configuration, the evaporation region comprises a first container and the preheating region a second container, the containers corresponding with one another by means of the fluid connection at least temporarily. The use of correspondingly configured closed containers for the evaporation region and the preheating region permits a reliable decoupling of the two regions, so that e.g. different pressure conditions may also prevail in the respective containers with respect to the different temperature conditions without any significant mutual interaction. The fluid connection may here be configured such that fluid can be conveyed from the preheating region into the evaporation region only temporarily or also continuously.

In a further embodiment, the fluid connection comprises a pump for conveying fluid from the preheating region to the evaporation region. The provision of a pump allows for a high degree of flexibility for operating the preheating region and the vapor generation region because e.g. in the evaporation region a higher pressure level may prevail by means of the pump without the conduction of the fluid being restricted thereby. Furthermore, the pump may e.g. be provided as a controllable pump so that the amount of the fluid introduced into the evaporation region may optionally be adapted to a varying demand for evaporated heat transfer medium.

In a further advantageous embodiment, a valve is provided in the fluid connection for preventing backflow from the evaporation region into the preheating region. With this constructional measure it is possible to maintain a pressure gradient between the evaporation region and the preheating region even upon standstill or failure of a corresponding pump in the fluid connection, so that a desired thermodynamic state in the evaporation region can also be maintained in the absence of the supply line of the liquid phase. Hence, the vapor generation system can be adapted in a very efficient way to strongly varying operating conditions, including a temporary interruption of the vapor supply for a soldering system.

In a further advantageous configuration, the vapor generation system comprises a pressure generation device in the preheating region that is configured to produce and maintain a predetermined pressure in the preheating region.

With this measure the pressure level can be adjusted in the preheating region in the desired manner, so that there is e.g. always a higher pressure level than in the evaporation region. In such an assembly, fluid can be introduced from the preheating region into the evaporation region due to the prevailing pressure difference. A pump can thereby be optionally omitted in the fluid connection, resulting in a smaller constructional volume, lower costs and less proneness to failure on the system's part. Furthermore, the temperature of the liquid phase can be controlled in a flexible manner by actuation with pressure in the preheating region because a higher temperature of the liquid phase in the preheating region as compared with the temperature of the liquid phase in the evaporation region is e.g. also possible. With a corresponding “superheating” of the liquid phase in the preheating region a heater in the evaporation region can possibly be dispensed with because the introduced liquid phase then boils at a lower temperature in the evaporation region. When a heater is provided in the evaporation region, an increased degree of controllability can be achieved through the pressure generation device with respect to vapor generation in the evaporation region because with respect to both the temperature in the preheating region and the pressure, as compared with the corresponding values in the evaporation region, a variation is possible in both directions. In a mode of operation in which the pressure in the preheating region is considerably above the pressure in the evaporation region, the temperature of the liquid phase in the preheating region can thus be kept above the corresponding boiling temperature in the evaporation region, so that due to the possibility of omitting a heater and e.g. due to the provision of a controllable valve means the evaporation region can be kept very small in terms of construction without any restrictions in the controllability of the vapor volume to be discharged.

In a further embodiment, the pressure generation device comprises a variable gas volume in the preheating region which can be compressed by the fluid in the preheating region. The pressure in the preheating region can be varied by the variable gas volume within wide limits, and it is particularly possible to use, on the one hand, the change in volume caused by the heating of the liquid phase and, on the other hand, a selective introduction or discharge of gas into or from the gas volume to set and maintain the desired pressure in the preheating region.

In a preferred embodiment, the pressure generation device comprises an elastic partition wall which separates the variable gas volume from the fluid in the preheating region. Hence, it can be ensured through a corresponding elastic partition wall that a gas in the gas volume does not intermix with the heat transfer medium. Hence, any desired inexpensive and easily available gas, e.g. atmospheric air, can be used for setting the desired pressure conditions in the preheating region.

In a further embodiment, the pressure generation device comprises a connection for communication with an external gas source. Hence, any desired specified gas can be introduced into the gas volume to produce the desired pressure conditions therewith. For instance, nitrogen can be introduced into the preheating region, and the pressure in the preheating region can be kept by means of the connection at a desired level due to communication with the external source of gas. For instance, a compressed air connection may also serve as the gas source, wherein a correspondingly high pressure can be set in the preheating region and a corresponding pressure relief valve means may be provided if the pressure in the preheating region exceeds the pressure predetermined by the compressed air device.

In a further advantageous embodiment, a device is provided at the inlet side of the preheating region for introducing the fluid in a controllable manner into the preheating region and for maintaining a specified pressure in the preheating region. With a corresponding device, e.g. in the form of a pump, it is possible on the one hand to introduce the fluid in a reliable manner into the preheating region, independently of the pressure conditions prevailing therein, and on the other hand to provide a control possibility of adjusting the pressure in the preheating region to a desired value. Especially in combination with corresponding means for pressure control of the variable gas volume, this yields a high degree of control flexibility under extremely small constructional efforts.

In a further advantageous embodiment, the vapor generation system comprises a first sensor means detecting the pressure in the preheating region. It is thereby possible to precisely monitor the pressure conditions prevailing in the preheating region.

In another embodiment, the vapor generation system comprises a second sensor means that senses the pressure in the evaporation region, thereby permitting a precise monitoring of the pressure conditions in the evaporation region.

In a further advantageous embodiment, the vapor generation system further comprises a control device which is connected to the second sensor means and is configured to control a manipulated variable influencing the pressure in the evaporation region. With such a control the pressure in the evaporation region can thus be set to a value which is required for the further use of the vapor. To be more specific, the heating power of a heater provided in the evaporation region and/or the fluid amount introduced from the preheating region into the evaporation region, and/or the temperature thereof, can be controlled in response to an output signal of the second sensor means. Advantageously, the control device comprises a control circuit so that even under varying operating conditions the vapor pressure can be adjusted in the evaporation region in a reliable and precise manner. With a corresponding control, it is possible to change the desired value for the pressure in the evaporation region and thus to adapt the mode of operation. For instance, if a constant pressure difference is to be maintained between the evaporation region and a process chamber, the pressure in the evaporation region can be readjusted in a reliable manner with a corresponding change in pressure in the process chamber.

In a further advantageous embodiment, the vapor generation system further comprises a first level-determining means for determining the liquid level in the evaporation region. It is thereby possible to monitor the liquid level, and especially the supply of the preheated fluid from the preheating region has the effect that the strong level variations known in conventional systems can be reduced considerably in small-sized evaporation systems, whereby the liquid level can be determined more precisely.

In another embodiment, a second level-determining means is provided for determining the liquid level in the preheating region. In this case it is also true that a substantial decoupling of the evaporation region and the preheating region largely avoids extreme level variations that may otherwise occur during introduction of a cold liquid into a conventional evaporator. To be more specific, corresponding compensation lines may be provided between the level determining means and the preheating region or the evaporation region, so that fluctuations in the display of the level can be reduced further. The level determining means may further be configured such that an optical monitoring, e.g. by an operator of the system, is possible at any time, and/or in the way that corresponding output signals can be supplied to a system control which then takes further measures on the basis of the supplied signals. For instance, with a decreasing liquid level in the preheating region, possibly together with an optional output or display of alarm messages, the supply of a heat transfer medium from an external reservoir may be requested for ensuring a still continuous operation of the system. It is also possible to use corresponding signals from the level determining means for other control tasks of the system, e.g. for controlling corresponding heating means.

In another advantageous embodiment, a heater is provided in the preheating region and/or in the evaporation region together with a first temperature-measuring means which is configured to output a signal corresponding to the temperature of a heater surface getting into contact with the fluid. With this measure it is possible to reliably ensure that the upper maximum temperature, e.g. a temperature critical for the heat transfer medium, is not exceeded so that the risk of a boiling-point temperature change or the creation of toxic substances can be prevented.

In another embodiment, a second temperature-measuring means is further provided for outputting a signal corresponding to the temperature of the liquid phase in the preheating region and/or in the evaporation region. It is thereby possible to monitor at least in one of the two regions or, in the presence of corresponding sensor means, in both regions, the actual temperature of the liquid phase and possibly to use it for the control of the system.

In a further embodiment, a third temperature-measuring means is provided for outputting a signal corresponding to the temperature of the vapor phase in the preheating region and/or in the evaporation region. It is thereby possible to monitor the thermodynamic conditions in the preheating region and/or the evaporation region even more precisely, and the corresponding signal output may also be used for controlling the conditions in the respective region. For instance, it is possible on the basis of the signal output to adjust the vapor temperature within certain limits independently of the temperature of the liquid. Furthermore, with the signals in cooperation with the corresponding signals supplied by the temperature measuring means for the temperature measurement of the liquid phase, it is possible to determine the pressure conditions prevailing in the respective region without the need for a corresponding pressure-sensitive sensor device.

Preferably, a control means is provided which is connected to the heater to receive the signal of the first temperature-measuring means, the control means being configured to keep the temperature of the surface of the heater at a specified value by outputting a first control signal.

As has already been mentioned, this measure reliably prevents a change in the properties of the heat transfer medium, the first control signal being e.g. used for controlling the heater and/or for controlling a corresponding means for generating an increased convection particularly near the surface of the heater. For instance, in the case of a rapid rise in the surface temperature the temperature of the heating surface and thus the temperature of the medium in direct vicinity of the heating surface can be kept below a critical value by reducing the heating power and/or by generating a corresponding flow on the surface for achieving an improved heat transfer and thus an improved cooling action.

Preferably, the control means is connected to the second temperature-measuring means to receive the signal of the second temperature-measuring means, the control means being further configured to control, by outputting a second control signal, the temperature of the surface of the heater on the basis of said second control signal. The signal of the second temperature-measuring means represents the temperature of the liquid phase in the preheating region and/or in the evaporation region, so that on the basis of said received signal the control means can produce the second control signal to efficiently control the surface of the heater, e.g. by changing the supplied heating power, changing a fluid flow on the surface of the heater, etc. Especially when the second temperature-measuring means is configured to detect both the temperature of the liquid in the preheating region and the temperature of the liquid in the evaporation region, the system can be controlled efficiently because the temperature-based control in both regions is possibly performed differently. For instance, it may be advantageous to provide several temperature-sensitive sensors in the preheating region, in which a relatively cold medium might be constantly supplied by pumping, so as to identify a temperature profile within the preheating region, and a corresponding control of the heater may then be performed on the basis of the present temperature profile. For instance, a flow inlet of the fluid connection may be provided at a side facing away from an inlet of the preheating region, so that with a corresponding large-area configuration of the heating surfaces, which may also comprise several separately controllable regions, a corresponding temperature profiling can be performed. To this end a corresponding flow path may be created for the fluid which extends along as many heating surfaces as possible, which are optionally also actuable in different ways, so that a high thermal contact with the heating surfaces is established over a very extensive area of the flow path. Hence, even at low levels in the preheating region, in the case of which upon introduction of major amounts of a cold fluid the temperature of the fluid would strongly decrease in all areas of the preheating region during blending, an adequately high minimum temperature of the fluid can be achieved after all at the flow entry of the fluid connection.

In a further embodiment, the control means is further connected to the heater to receive the signal of the third temperature-measuring means, the control means being configured to control, by outputting a third control signal, the temperature of the surface of the heater on the basis of the third control signal. Since the third temperature-measuring means outputs a signal representative of the gas phase in the preheating region and/or in the evaporation region, it is possible to control the heater accordingly also in consideration of the gas phase temperature.

In a further advantageous embodiment, the fluid connection has a substantially horizontal flow outlet. This measure accomplishes a flow and thus a convection and enhanced heat transfer in the liquid phase of the medium in the evaporation region through the introduction of the fluid from the preheating region. Advantageously, the flow outlet is positioned deep below the typical liquid level, e.g. near the bottom area of the evaporation region, so that, on the one hand, an improved heat transfer takes place without causing, on the other hand, any major interference on the surface of the liquid.

In a further configuration, a supply line is provided for the preheating region, the supply line having a substantially horizontal flow outlet, resulting in a flow for improved heat exchange with the already existing liquid in this instance as well. The flow outlet may also be arranged relatively far below the typical liquid level, e.g. near the bottom area, so that the liquid surface is hardly disturbed by the introduction of the medium. Due to this measure the liquid level can be determined with high accuracy, if necessary.

In a further advantageous embodiment, the vapor generation system is provided at least in the preheating region with a device for generating a convection flow of the fluid. The device may comprise stirrers, pumps, guide elements, or the like. For instance, in an advantageous variant, one or several deflection elements, which may be configured as heatable surfaces, may be arranged between the fluid inlet and the fluid outlet in the preheating region, so that an inflowing fluid volume must travel a relatively long distance to reach the outlet, and the fluid volume is here possibly conducted near a heated surface. This can accomplish a convection without the provision of complicated mechanical devices and, when the deflection elements are configured as heating elements, a very large heating surface is provided together with a small constructional volume at the same time.

In a further embodiment, the evaporation region is arranged inside the preheating region. This constructional measure can improve the efficiency of the vapor generation system considerably. For instance, the fluid in the preheating region may be used for preheating or insulating the vessel wall of the evaporation region. For instance, a much less expensive insulation, or possibly no special insulation at all, is required for the vessel walls of the evaporation region because the temperature of the fluid surrounding the evaporation region is already close to the temperature prevailing in the evaporation region. In other cases, the evaporation region may be provided over a large surface with corresponding heating surfaces on the outsides and/or on the insides, so that e.g. additional heating surfaces are available with a minimum constructional volume of the total vapor generator. Furthermore, the fluid connection may thereby be made extremely short and thus shows low loss. Especially during operation of the preheating region at a pressure above the pressure in the evaporation region, the fluid connection may be implemented with an opening and with a valve means provided therein, the valve means allowing fluid flow only in the direction of the evaporation region. This helps to further reduce the overall constructional volume because a separate conveying means is not needed.

According to a further aspect of the present invention a soldering system is provided which comprises at least one process chamber to be actuated with vapor of a heat transfer medium. Furthermore, the soldering system comprises a vapor generation system, as shown in the preceding embodiments and in embodiments to be still described. Furthermore, a vapor supply line is provided which connects the vapor generation system to the process chamber.

Due to the combination of the vapor generation system of the invention with a soldering system, it is possible to achieve, in particular, the objectives formulated in the object of the present invention, i.e. to provide vapor in adequate amounts in the at least one process chamber at all times.

In a further advantageous configuration, the soldering system comprises a pressure sensor in the process chamber, so that the corresponding pressure conditions can be monitored at all times and possibly used for control purposes.

In a further embodiment, a controllable valve means is provided in the vapor supply line. Said controllable valve means permits the controlled supply of the vapor into the process chamber to produce corresponding conditions on the subassembly to be processed. Especially with a pressure gradient from the evaporation region to the process chamber, the vapor amount and thus optionally the temperature in the process chamber can be controlled without the need for a pump.

To this end the soldering system is advantageously provided with a system control which is operatively connected to the pressure sensor and configured to actuate the controllable valve means on the basis of a signal output from the pressure sensor. A correspondingly configured system control therefore simplifies the means needed for maintaining desired conditions in the process chamber insofar as only a valve means that is hardly prone to mechanical failure is provided, so that in the presence of a pump no complicated control system is needed for the pump, or a pump for conveying vapor can be dispensed with altogether in a special embodiment.

In a further advantageous embodiment, the system control is connected to the control device in the vapor generation system and configured to instruct said control means to adjust the pressure in the evaporation region including the signal from the pressure sensor. A desired pressure difference can e.g. be maintained in this way between the evaporation region and the process chamber, so that the supply of vapor to the process chamber can be accomplished without any active conveying means.

Advantageously a return line is also provided which connects the process chamber to the preheating region of the vapor generation system. A permanent backflow of the heat transfer medium takes place in this way, the relatively low temperature of the condensate in the preheating region being then brought to a correspondingly higher desired temperature. The fluctuations which can often be observed in conventional soldering systems are thereby reduced considerably or can be eliminated altogether in vapor generation. In a further embodiment, the return line is connected to the pressure generation device in the vapor generation system. The condensate can thereby be introduced from the process chamber via the return line according to the desired pressure conditions in the preheating region into said region, so that constant conditions can be observed, or with the help of the pressure generation device, the introduction of the condensate can be used for establishing and maintaining a desired pressure condition in the preheating region. Advantageously, a flow outlet of the return line in the preheating region is predominantly arranged in horizontal fashion so that an efficient convection can be achieved in the fluid. Especially when the flow outlet is distinctly below the liquid level of the medium in the preheating region, a negative impact on the surface of the liquid can largely be avoided.

Under another aspect of the present invention a method is provided for operating a soldering system, the method comprising maintaining a pressure gradient between an evaporation region of a vapor generator and a process chamber to be fed with vapor by monitoring the pressure of the process chamber, and introducing the vapor into the process chamber by exploiting the pressure gradient.

Hence, this method provides a simple technique which is thus not prone to failure and also an efficient one for conducting the vapor from the evaporation region to the process chamber because due to the pressure monitoring of the process chamber the pressure difference can always be kept at an appropriate value and pumps are thus in principle not needed for conveying the vapor. This achieves a particularly compact construction of a corresponding soldering system, so that this method, in particular, can also be carried out with conventional soldering systems by way of a slight constructional modification.

In a further advantageous embodiment, the method also comprises determining a first characteristic value representative of the pressure in the process chamber, determining a second characteristic value representative of the pressure in the vapor generation region, and controlling the amount of vapor introduced into the process chamber in response to the first and second characteristic value. This type of process control thus takes into account the conditions prevailing in the process chamber and in the vapor generation region, so that it is possible to react rapidly and efficiently to changes in the process chamber at the evaporator side. Preferably, the introduced amount of vapor is defined by adjusting a controllable valve element. With little technical equipment this accomplishes an extremely precise control, in contrast to conventional devices in which with increased technical equipment fluctuations in the process chamber may typically lead to uncontrolled fluctuations in the vapor generator.

Under another aspect of the present invention, said invention is directed to a method for operating an evaporation system. In this method, a heat transfer medium to be evaporated is first preheated and the preheated heat transfer medium is then introduced into an evaporation region where it is then converted into the vapor phase.

This method substantially yields the same advantageous effects as have already been listed with respect to the evaporation system of the invention. Advantageously, the heat transfer medium is preheated to a temperature near the boiling temperature, i.e. the boiling temperature in the evaporation region, so that the introduction of the preheated medium does not lead to any significant interference with the thermodynamic conditions in the evaporation region.

Furthermore, the pressure in the evaporation region can advantageously be adjusted to a value which is equal to or greater than a specified minimum pressure. It can thus be ensured that e.g. a certain required amount of vapor can be provided at all times. To be more specific, the minimum pressure can be specified such that it is always higher than a corresponding pressure in the process chamber, so that vapor can be supplied by exploiting the resulting pressure gradient. To this end a characteristic value which is representative of the pressure in the evaporation region is suitably sensed and the evaporation process is controlled on the basis of said characteristic value. The evaporation process can e.g. be controlled by controlling the heating power and/or by controlling the supply of the preheated heat transfer medium.

In a further advantageous embodiment, preheating takes place in a preheating region, and a pressure gradient is produced between the preheating region and the evaporation region, so that the heat transfer medium is introduced into the evaporation region by exploiting said pressure gradient. This reduces the technical equipment for providing the preheated fluid in the evaporation region because active conveying means might not be needed. To be more specific, it is possible to use a vapor generation system which has been described before, and a corresponding pressure generation device is e.g. contained therein, so that a corresponding pressure gradient can inter alia be achieved by one of the above-described measures.

### BRIEF DESCRIPTION OF THE DRAWINGS

Further advantageous embodiments are also indicated in the attached patent claims and in the following detailed description in which reference is made to the following drawings, of which:

FIG. 1 shows an exemplary embodiment of a vapor generation system according to the present invention;

FIG. 2 schematically shows a further embodiment of a vapor generation system with a large effective heating surface; and

FIG. 3 schematically shows a soldering system and the operative principle thereof, wherein a vapor generation system is used with a preheater.

### DETAILED DESCRIPTION

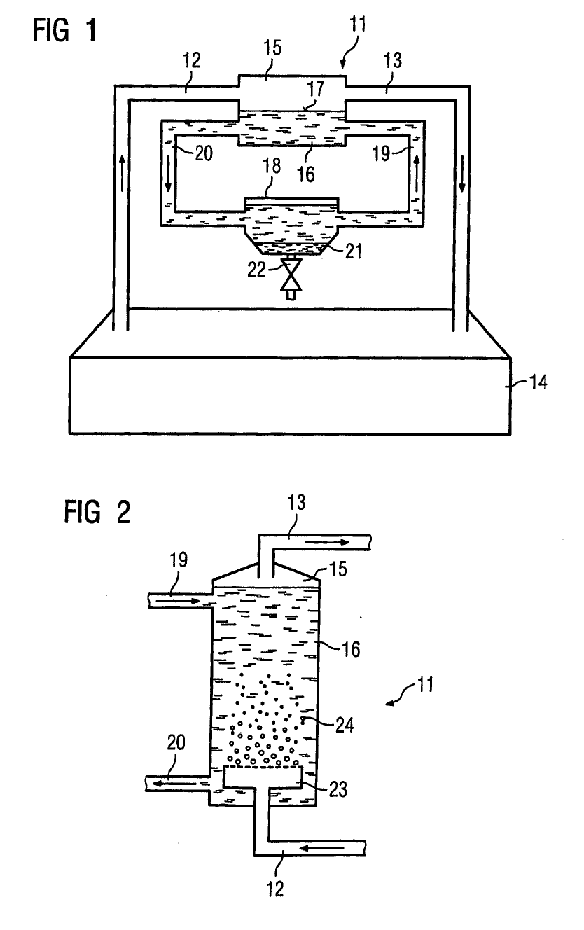

FIG. 1 is a schematic view showing a vapor generation system 100, wherein a preheating region 110 and a vapor generation region 120 are coupled by means of a fluid connection 130. The preheating region 110 comprises a supply line 111 which comprises a valve 112 at the inlet side and a flow outlet 113 at the outlet side. Preferably, the flow outlet 113 is arranged substantially horizontally in the operative position of the vapor generation system 100 to efficiently effect a convection flow in a liquid contained in the preheating region 110 during operation. The flow outlet 113 is preferably arranged deep below a liquid level 140. For instance, a typical distance of the flow outlet 113 from the liquid level 140 is within the range of several centimeters in a typical operative phase. To guarantee a correspondingly deep position of the flow outlet 113 for many possible liquid levels during operation, the flow outlet 113 may be arranged in the vicinity of the bottom area of the preheating region 110, i.e. it may have a distance of a few mm to about 20 mm. In other embodiments (not shown), the supply line 111 may also be introduced e.g. from below into the preheating region 110.

Furthermore, the preheating region 110 comprises a heater 114 with one or several heating elements, each having a corresponding surface 114a which gets into contact with the liquid phase of the heat transfer medium. Preferably, the heating device 114 is configured such that the total available surface 114a is as large as possible, so that despite the relatively disadvantageous thermodynamic properties of the heat transfer medium an efficient heating can be carried out. For instance, the heater 114 may comprise a plurality of individual tubes that are heated, for instance, by means of a corresponding medium or electrically, resulting in a large surface 114a on the whole. In other cases corresponding ribs may be provided in the heater 114. The heater 114 may be configured as a controllable heater, and in some embodiments the heating power is separately adjustable for different regions. Furthermore, in the illustrated embodiment sensor elements 116a, 116b and 116c are provided, each being adapted to output signals representative of the temperature. In the illustrated embodiment, sensor 116a, for instance, is in thermal communication with the surface 114a, so that the temperature thereof can be monitored. Furthermore, sensor 116b is arranged such that a thermal contact is established with the liquid phase of the medium under typical process conditions. Likewise, sensor 116c may be arranged such that a signal representative of the temperature of the gas phase in the preheating region 110 can be obtained. Furthermore, a means 115 is provided for determining the liquid level 140, the means being in fluid communication with the preheating region 110. This has the effect that possibly arising turbulence in the heated liquid surface 140 has no significant influence on the determination of the liquid level. Furthermore, a compensating line 115a may be provided between the device 115 and the preheating region 110 to reduce or avoid the formation of pressure differences between the device 115 and the preheating region 110, if necessary. Moreover, a pressure relief valve 117 may be provided to prevent an excessive rise in pressure in the preheating region 110, if necessary. Advantageously, the preheating region 110 is designed as a container which can withstand an increased pressure, e.g. in the order of some bars, the pressure relief valve 117 being dimensioned to prevent an inadmissible pressure load on the container. The pressure relief valve 117 also prevents a situation where the maximally admissible temperature of the liquid, e.g. 300° C., is exceeded. Furthermore, an outlet line 118 including a corresponding valve element may be provided, so that the container of the preheating region 110 can be emptied and rinsed, if necessary.

The evaporation region 120 may have a structure which is in principle similar to the preheating region 110 if this is of advantage for constructional reasons. In other embodiments, however, the evaporation region 120 and the preheating region 110 may considerably differ from one another. For instance, it may be advantageous to make the dimensions of the preheating region 110 much larger than the corresponding dimensions of the evaporation region 120. In the illustrated embodiment, the evaporation region 120 comprises a heating means 125 which may be constructed as explained above with reference to the heating means 114. To be more specific, the heating means 124 may comprise corresponding heating surfaces 124a which, in turn, are in thermal contact with a corresponding sensor element 126a so that the surface temperature of the heating means 124 can be detected at least in one or, optionally, in several positions. To be more specific, the heating means 124 is designed as a controllable heater which is operatively connected to a control device 150. Furthermore, other temperature-sensing sensor elements 126b and 126c may be provided in the evaporation region, the sensor elements being arranged to supply a signal corresponding to the temperature of the liquid phase and a signal corresponding to the temperature of the gas phase of the medium contained in the evaporation region 120. Furthermore, a means 125 for measuring the liquid level may be provided with a corresponding compensation line 125a. A pressure relief valve 127 and a corresponding outlet line 128 with a corresponding valve may be provided by analogy with the preheating region 110 to provide the possibility of increased pressure and of cleaning the container of the evaporation region 120. Furthermore, a sensor 129 which senses the pressure in the evaporation region 120 is provided which is operatively connected to the control device 150 so that a signal representative of the pressure can be supplied to the control device 150. Furthermore, a vapor line 160 is provided with a corresponding valve element 161 which is advantageously designed as a controllable valve element to supply the vapor e.g. to a process chamber of a soldering system.

In the illustrated embodiment, the fluid connection 130 comprises a pump 131 and a valve element 132, which is configured to prevent a backflow of fluid from the evaporation region 120 into the preheating region 110 if there is a corresponding pressure gradient between said two regions. Furthermore, the fluid connection 130 comprises an inlet line 133 with a substantially horizontal flow inlet 135, and an outlet line 135 with a substantially horizontal flow outlet 136. It should be noted that the fluid connection 130 in FIG. 1 is just shown schematically and may have any desired configuration and length as required for a fluid connection between the containers of the preheating region 110 and the evaporation region 120. Furthermore, the fluid connection 130 has an appropriate insulation if it extends over long distances outside the preheating region 110 and/or the evaporation region 120, so that a temperature drop between the flow inlet 134 and the flow outlet 136 is insignificant and has substantially no impact on the thermodynamic stability in the evaporation region 120.

A suitable insulation can be accomplished with known means, e.g. by a jacket containing insulating materials, such as glass fiber mats or mineral wool, etc.

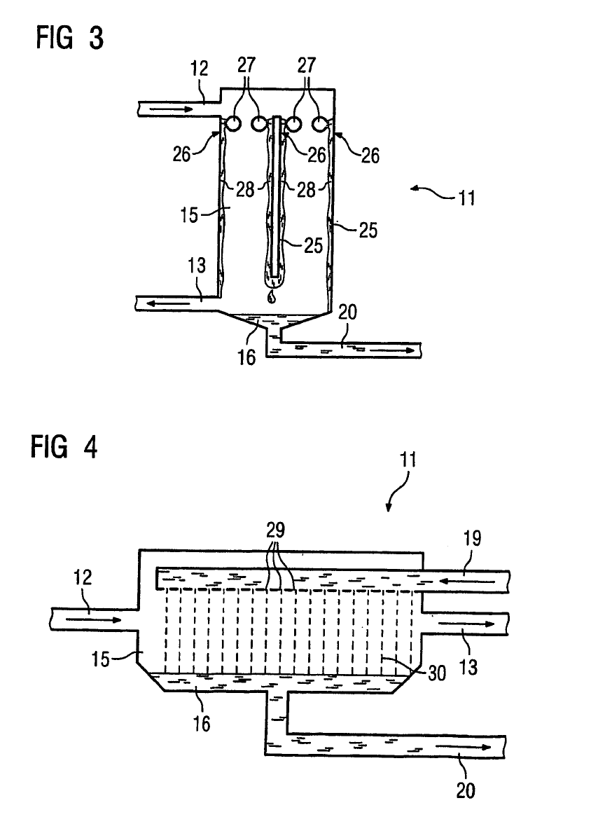

During operation of the vapor generation system 120, the heat transfer medium in liquid phase is introduced via the inlet line 112 and via the valve element 112, for instance, from a process chamber or another container into the preheating region 110. The supply of the medium can be controlled by a corresponding means (not shown) such that the liquid level 140 remains within a defined range, which can be monitored or optionally adjusted by the means 115. With the introduction of the medium by means of the substantially horizontal-flow outlet 113, a thorough blending can already be accomplished within the preheating region 110 because the flow outlet 113 is arranged particularly in the vicinity of the heater 114, so that convection takes place from the flow outlet 113 to the flow inlet 134 via the large heating surfaces 114a. However, other means may also be provided for generating a convection flow in the liquid, e.g. in the form of corresponding stirrers, deflection elements, or the like. A corresponding embodiment with deflection elements will be described hereinafter with reference to FIG. 2.

The temperature of the heater 114, i.e. especially the temperature of the surface 114a getting into contact with the liquid, is sensed by one or a plurality of the sensors 116a and is typically limited to a specific value by way of a corresponding control device (not shown), so that a temperature which is maximally admissible for the heat transfer medium is not exceeded. Furthermore, the temperature of the liquid phase and the gas phase of the medium can be monitored and controlled with the corresponding temperature sensors 116b and 116c. For instance, the heating power supplied to the heater 114 can be controlled in accordance with the output signal of the sensor 116b such that the temperature of the liquid in the preheating region 110 is close to the temperature of the liquid in the evaporation region 120. Depending on the pressure conditions prevailing in the respective regions, the temperature of the liquid in the preheating region 110 may here be lower than, substantially equal to, or greater than the temperature of the liquid phase in the evaporation region 120. A relatively stable operation in the evaporation region 120 can be achieved if the temperature of the supplied fluid just differs by a few degrees Celsius from the boiling temperature prevailing in the evaporation region 120. For instance, the preheating region 110 and the evaporation region 120 can be operated under substantially identical pressure conditions, so that the corresponding boiling temperatures are substantially identical as well. In this mode of operation, liquid can then e.g. be supplied at a temperature differing only slightly from the boiling temperature in the evaporation chamber 120, the insignificant deviations being caused by possible instable conditions in the preheating region 110 during introduction of the relatively cold medium. Since these fluctuations are however substantially offset in the preheating region 110, a relatively stable operation of the evaporation chamber 120 is ensured. The fluid preheated to a desired temperature is then introduced into the evaporation region 120, the heater 124 being then controlled in an advantageous embodiment such that the temperature of the surface 124a, on the one hand, remains below a required maximum value and the vapor pressure, on the other hand, which is sensed by means of the sensor 129, is within a predetermined range. In other embodiments, other parameters, such as the amount of preheated fluid introduced via the fluid connection 130, can be used for keeping the vapor pressure at a desired level. For instance, upon a sudden demand for vapor, which is to be provided via the outlet line 160 in a process chamber for example, the amount of the fluid introduced into the evaporation region 120 can be increased considerably for a short period of time, so that the increase in volume of the liquid compensates for the decrease in vapor volume at least to some degree, and the heating power can here also be raised at the same time for providing the increased vapor amount also for a longer period of time. With the means 125 the liquid level in the evaporation region 120 can be monitored permanently and/or used for controlling the operation of the evaporation region 120, as described in a similar way before with reference to the preheating region 110. Especially with the control device 150 which receives at least one signal of the pressure sensor 129 as input, it is thereby possible to accomplish an efficient control of the operation of the evaporation region 120 because with the setting of a desired pressure in a continuous operation an adequate supply of a corresponding process chamber is also ensured. Furthermore, the control device on the basis of the pressure sensor 129 also permits a certain compensation of short-term variations in vapor demand that may e.g. be caused by corresponding pressure variations in the process chambers.

FIG. 2 schematically shows a further illustrative embodiment of the present invention. A vapor generation system 200 comprises a preheating region 210 and an evaporation region 220, a fluid connection 230 and a control device 250. Furthermore, there is provided a pressure generation device 270, an inlet region 280 at the inlet side of the preheating region 210, and an outlet 260 at the outlet side of the evaporation region 220.

The preheating region 210 may be provided in the form of a container, as is advantageous for constructional reasons for specific uses. To be more specific, as shown in FIG. 2, the preheating region may have a larger volume than the evaporation region 220, the evaporation region 220 being arranged inside the preheating region 210 in the illustrated embodiment. The preheating region comprises a heater 214 with corresponding surfaces 214a, and the elements which carry the individual heating surfaces 214a and are also just designated with reference numeral 214a are here arranged as deflection elements in the illustrated embodiment to produce a convection flow in the preheating region 210. In the illustrated embodiment, these may e.g. be plates which are alternatingly mounted on the bottom and the ceiling of the preheating region 210, so that with a corresponding convection flow a relatively long contact is established with the corresponding heating surfaces 214a. The heater 214 may comprise further heating elements (not shown), and deflection elements may also be provided that are not configured as heating elements. Furthermore, it should be noted that the configuration shown in the figure is just of an exemplary nature and it is also possible to establish other flow paths by means of corresponding deflection elements. Further provided are corresponding temperature sensor means 216a that are e.g. in thermal contact with one or a plurality of the heating surfaces 214, and one or a plurality of corresponding temperature sensor means 216b that are in thermal contact at one or several places with a fluid to be heated in the preheating region 210. In other embodiments, the outer wall of the evaporation region 220, which is designated by 220a, may e.g. be designed completely or in part as a heatable surface so that a very large and effective heating surface is provided on the whole for heating the fluid in the preheating region 210. Furthermore, a level meter 215 is provided, which is e.g. configured in a similar way as the means 115 of FIG. 1.

The inlet region 280 serves the introduction of a medium into the preheating region 210. To this end the inlet region may comprise a pump 281 and/or a corresponding valve element 282 which is designed as a controllable valve in an advantageous embodiment. Furthermore, a reservoir 283 may be provided which is connected by means of a controllable valve 284 to the preheating region 210, so that in case of need an additional amount of the heat transfer medium can be fed into the preheating region 210.

The pressure generation device 270 comprises a gas volume 273 which may e.g. be represented by the spatial region above the liquid phase, a connection 271 being provided so that the gas volume 273 communicates with a source of gas (not shown) by means of a controllable valve 272. The gas volume 273 may also be separated by an at least partly flexible membrane 274 from the remaining space of the preheating region 210, but the flexible membrane permits a change in the gas volume 273. Furthermore, a pressure sensor 219 is provided that may be arranged in the gas volume 273 and/or in the remaining space above the liquid phase.

In some embodiments, the evaporation region 220 may comprise a heater 224 which is preferably designed as a controllable heater, and it may be also be without a heater if the vapor generation system 200 is configured for a corresponding operation. The evaporation region 220 is connected by means of the fluid connection 230 to the preheating region 210, a controllable valve element 232 and optionally a pump (not shown) being provided for introducing the fluid into the evaporation region 220. Furthermore, a pressure sensor 229 is provided in the area of the vapor phase. The outlet line 260 establishes a fluid connection by means of a controllable valve 261, e.g., to a process chamber of a soldering system. As is also shown in FIG. 2, at least the sensor 229 is connected to the control device 250, and in advantageous embodiments further controllable means and sensor elements, e.g. the temperature sensors 216a, 216b, the heaters 214 and 224, and the corresponding valve elements 272 in the pressure device 270, the valve 282 in the inlet region 280, the valve 232 in the fluid connection 230, and the valve 261 in the outlet line 260, are connected to the control device.

During operation of the evaporation system 200 the fluid is filled up to a desired liquid level, which can be monitored by the device 215, and is heated by the heating means 214 in an efficient manner to a desired temperature. The pressure prevailing in the preheating region 210 can here be chosen by means of the pressure generation device 270 such that said pressure is smaller than, equal to, or greater than the pressure prevailing in the evaporation region 220. Especially if the pressure is adjusted by means of the pressure generation device 270 and/or the pump 281 and the valve 282 in such a manner that said pressure is greater than the desired pressure in the evaporation region 220, the fluid can be introduced into the evaporation region 220 via the fluid line 230, exclusively by exploiting the pressure gradient, and the amount to be introduced can optionally be controlled via the valve means 232 and/or the magnitude of the pressure in the preheating region 210. In this mode of operation, the valve element 232 is designed such that it does not allow any backflow of the fluid. For instance, a source of gas can be connected at a constant pressure by means of connection 271, and the fluid is introduced via the inlet region 280 under pressure, so that a desired level remains substantially constant. The fluid which is supplied in a relatively cold state then travels along the surfaces or the deflection elements 214a and is efficiently heated up in this process and is thus present at the input of the fluid line 230 with the final desired temperature, which may be around the boiling temperature in the evaporation region 220 or also above said temperature, and is then introduced via the valve 232 into the evaporation region 220. Depending on the conditions, the fluid can already be introduced in a vaporous state due to a drop in pressure in the fluid connection 230 or can be introduced as liquid, and the further evaporation may then take place by means of the heater 224. To be more specific, in the arrangement shown in FIG. 2, the evaporation region 220 is permanently surrounded at least in part by the flow of preheated fluid, so that the demands made on a corresponding insulation of the wall of the evaporation region 220 can be correspondingly low. When the wall 220a is designed as a heating element, this simultaneously yields increased efficiency for heating the fluid in the evaporation region 220. The produced amount of vapor can here be controlled again by means of the pressure sensor 229 in such a manner that the heating power of the heater 224, if such a heater is provided, and/or the amount of the supplied fluid are adjusted by means of the valve 232 and a possibly provided pump and/or via the pressure generation device 270 in combination with the inlet region 280. In a mode of operation in which the pressure in the preheating region 210 is permanently higher than the pressure in the evaporation region 220, the technical equipment can thus be kept small, e.g. a pump can be omitted in the fluid line 230, and a high degree of process stability can here be achieved after all. Furthermore, a very compact constructional volume can be achieved with the illustrated structure. Of course, other modes of operation are also feasible with the system 200. Furthermore, if required, the components of the systems 100 and 200 can be replaced or supplemented. For instance, the preheating region 110 and 210, respectively, and/or the evaporation region 120 and 220, respectively, may be provided as two or more containers, which may be identical in structure or different. With some applications it may be advantageous when two or more preheating containers are operated in “cascade” form or in parallel to achieve an even more efficient decoupling with respect to instabilities. Likewise, several evaporation containers of a very small volume may be provided and controlled in a suitable manner such that the necessary amount of vapor is always available.

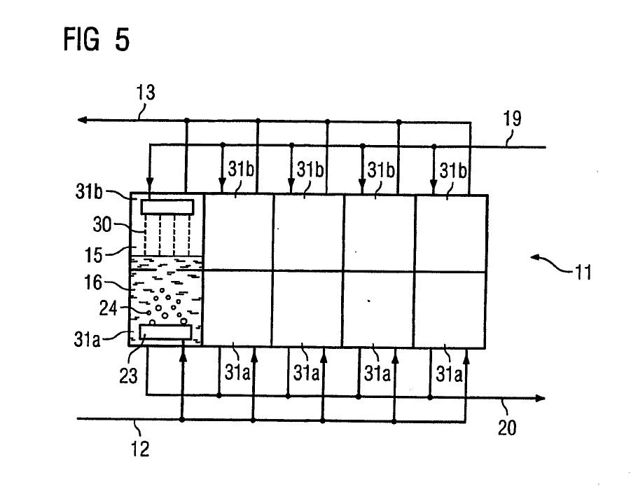

FIG. 3 schematically shows a soldering system 390 which comprises one or several process chambers 301a, 301b which are connected to a vapor generation system 300 via a corresponding line 360 and vapor valve 361. The vapor generation system 300 comprises a preheating region 310 and an evaporation region 320 with a sensor 329 which can output a signal representative of the pressure in the gas phase of the evaporation region 320 to a control device 391. The vapor generation system 300 may be configured in any desired way, as described in the previously illustrated embodiments. To be more specific, the vapor generation system 300 may be constructed in accordance with system 100 or system 200 or a combination thereof. The preheating region 310 is connected to the process chambers 301a, 301b via corresponding lines, collection containers, or the like, by means of a pump 381 and a valve 382. Furthermore, a pressure sensor 302a, 302b which can output a signal representative of the pressure in the corresponding process chamber to the control device 391 is provided in at least one of the process chambers 301a, 301b.

During operation of the soldering system 390 the control device 391 receives corresponding signals from the sensors 302a, 203b, so that the pressure level is known in the individual process chambers. Furthermore, vapor generation in the system 300 is controlled on the basis of the signal of sensor 329 in a way as described previously, for instance, with reference to FIGS. 1 and 2. In one embodiment, the control device 391 can control the system 300 such that a desired pressure gradient is always maintained between the vapor generation region 320 and the process chambers 301a, 301b. The vapor can then be introduced into the process chambers by exploiting the pressure difference, and a flow control may here be carried out in addition by means of the valve element 361.

In advantageous embodiments, the control device 391 may also take over the function of the control devices 150 and 250, respectively.

Hence, the present invention permits a more stable and efficient vapor generation, and a continuous supply of one or more process chambers of a soldering system can here be achieved without any significant influences of the temperature of the medium returned into the vapor generation system. Especially due to the vapor generation control based on the pressure in the vapor phase, in combination with a preheating of the heat transfer medium, a continuous vapor supply can be ensured. Furthermore, the control strategy according to the invention with maintenance of a pressure gradient between the vapor generation system and the process chamber permits the omission of a corresponding active pump in the vapor supply line. Furthermore, the above-illustrated structural and constructional measures make it possible to keep the outer dimensions of the vapor generation system small, so that already known soldering systems can also be retrofitted by being modified only slightly.

1. A vapor generation system for soldering systems, comprising:
an evaporation region configured for evaporation of a heat transfer medium;
a preheating region configured for heating the heat transfer medium to or above a predefined temperature, an adjustable upper maximum temperature being not exceeded; and
a fluid connection provided between the evaporation region and the preheating region configured to conduct a fluid flow from the preheating region to the evaporation region.

2. The vapor generation system according to claim 1, wherein the evaporation region comprises a first container and the preheating region a second container that correspond with one another by means of the fluid connection at least temporarily.

3. The vapor generation system according to claim 1, wherein the fluid connection comprises a pump for conveying fluid from the preheating region to the evaporation region.

4. The vapor generation system according to claim 3, wherein the fluid connection has disposed therein a valve which prevents backflow from the evaporation region into the preheating region.

5. The vapor generation system according to claim 1, the system further comprising a vapor generation device provided in the preheating region, which is configured to produce and maintain a predetermined pressure in the preheating region.

6. The vapor generation system according to claim 5, wherein a device is provided at the inlet side of the preheating region, the device being configured to introduce the fluid in a controllable manner into the preheating region and to maintain a specified pressure in the preheating region.

7. The vapor generation system according to claim 1, the system further comprising a first sensor sensing the pressure in the preheating region.

8. The vapor generation system according to claim 1, further comprising a second sensor sensing the pressure in the evaporation region.

9. The vapor generation system according to claim 8, further comprising a control device which is connected to the second sensor and which is configured to control a manipulated variable influencing the pressure in the evaporation region.

10. The vapor generation system according to claim 9, further including a controllable heater which is connected to the control unit.

11. The vapor generation system according to claim 9, wherein the control device is operatively connected to the fluid connection to introduce the fluid flow in a controllable manner into the evaporation region.

12. The vapor generation system according to claim 1, further comprising a first level-determining means for determining the liquid level in the evaporation region.

13. The vapor generation system according to claim 1, further comprising a second level-determining means for determining the liquid level in the preheating region.

14. The vapor generation system according to 1, wherein at least one of the preheating region and the evaporation region has disposed therein a heating device with a first temperature-measuring unit configured to output a signal corresponding to the temperature of a fluid-contacting surface of the heater.

15. The vapor generation system according to claims 1, wherein the evaporation region is arranged inside the preheating region.

16. A soldering system comprising:
at least one process chamber which is to be acted upon with vapor of a heat transfer medium;
a vapor generation system for soldering systems, comprising:
an evaporation region configured for evaporation of a heat transfer medium;
a preheating region configured for heating the heat transfer medium to or above a predefined temperature, an adjustable upper maximum temperature being not exceeded;
a fluid connection provided between the evaporation region and the preheating region configured to conduct a fluid flow from the preheating region to the evaporation region; and
a vapor supply line which connects the vapor generation system to the process chamber.

17. The soldering system according to claim 16, further comprising a sensor sensing the pressure in the process chamber.

18. The soldering system according to claim 16, further comprising a controllable valve unit in the vapor supply line.

19. The soldering system according to claim 18, further comprising a system control which is operatively connected to the sensor and configured to actuate the controllable valve unit on the basis of a signal output by the sensor.

20. The soldering system according to claim 19, further comprising a control device which is connected to the second sensor and which is configured to control a manipulated variable influencing the pressure in the evaporation region, wherein the system control is connected to the control device and configured to instruct the control device to adjust the pressure in the evaporation region, including the signal from the sensor.

21. The soldering system according to claim 16, further comprising a return line which connects the process chamber to the preheating region.

22. The soldering system according to claim 21, further comprising a device at the inlet side of the preheating region, the device being configured to introduce the fluid in a controllable manner into the preheating region and to maintain a specified pressure in the preheating region. wherein the return line is connected to the pressure generation device.

23. The soldering system according to claim 16, wherein a flow outlet of the return line in the preheating region is arranged in substantially horizontal fashion.

24. A method for operating a soldering system, comprising
maintaining a pressure gradient between an evaporation region of a vapor generator and of a process chamber to be fed with vapor by monitoring the pressure in the process chamber; and
introducing vapor into the process chamber by exploiting the pressure gradient.

25. The method according to claim 24, further comprising:
determining a first characteristic value representative of the pressure in the process chamber;
determining a second characteristic value representative of the pressure inn the vapor generation region; and
controlling the amount of vapor introduced into the process chamber in response to the first and second characteristic value.

26. The method according to claim 25, wherein the introduced amount of vapor is determined by adjusting a controllable valve element.
